(19) United States
(12) Patent Application Publication
(10) Pub. No.: US 2025/0286302 A1
(43) Pub. Date: Sep. 11, 2025

(54) CONNECTOR AND CONNECTOR MANUFACTURING METHOD

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Teruo HARA, Mie (JP)

(21) Appl. No.: 18/862,554

(22) PCT Filed: Apr. 24, 2023
(86) PCT No.: PCT/JP2023/016076

§ 371 Date: Nov. 4, 2024

(30) Foreign Application Priority Data
May 11, 2022 (JP) 2022-077959

(51) Int. Cl. H01R 13/424; H01R 43/20

(52) U.S. Cl. CPC H01R 13/424; H01R 43/20

(57) ABSTRACT

A connector 10 comprises an electric wire 40 having a core wire 41 and an insulating coating 42 covering the outer periphery of the core wire 41, a terminal 50 connected to the core wire 41, a connector housing 20 having a terminal storage part 21 in which the terminal 50 is stored, and a rear holder 30 attached to the rear end portion of the connector housing 20. The rear holder 30 has an electric wire insertion hole 33 in which the electric wire 40 is inserted, the terminal 50 includes an insertion cylindrical part 55 in which the core wire 41 is inserted from the rear and a contact part 56 that is disposed at the rear end portion of the insertion cylindrical part 55 and faces the electric wire insertion hole 33, the insulating coating 42 of the electric wire 40 has a sheath portion 43 and a body portion 44 as separate portions, and the sheath portion 43 is disposed in front of the body portion 44 and is slidable with respect to the core wire 41.

### TECHNICAL FIELD

The present disclosure relates to a connector and a connector manufacturing method.

### BACKGROUND

Conventionally, a female terminal described in Japanese Patent Laid-Open Publication No. 2019-145208 (Patent Document 1 below) is known. This female terminal is provided with a terminal body including deformable upper and lower connection pieces extending in an extension direction, and a slide portion movable in the extension direction with respect to the terminal body. By moving the slide portion with a core wire of a wire disposed between the upper and lower connection pieces, upper and lower contact portions provided in the slide portion press the upper and lower connection pieces against the core wire, whereby the terminal body and the wire can be electrically connected. Further, a connector provided with a connector housing for accommodating the female terminal and a rear holder to be attached to a rear end part in the extension direction of the connector housing is described as a connector provided with this female terminal in Patent Document 1 below.

### PRIOR ART DOCUMENT

### Patent Document

Patent Document 1: JP 2019-145208 A

### SUMMARY OF THE INVENTION

### Problems to be Solved

The above connector is manufactured as followed. First, the female terminal is accommodated into the connector housing and the rear holder is assembled with the rear end part of the connector housing. In this state, the rear holder is held at a temporary locking position with respect to the connector housing. Then, the wire is inserted through an insertion hole of the rear holder and the core wire of the wire is inserted into the inside of the female terminal. At this time, the core wire is disposed between the upper and lower connection pieces. Subsequently, by moving the slide portion forward with respect to the terminal body, the upper and lower contact portions press the upper and lower connection pieces against the core wire, and the female terminal and the wire are connected. Finally, the rear holder is moved to a complete locking position forward of the temporary locking position and the female terminal is retained in the connector housing, whereby the manufacturing of the connector is completed.

In the above connector, a front end part of the core wire may possibly contact a rear end part of the female terminal and it may be difficult to insert the core wire into the inside of the female terminal when the core wire is inserted into the inside of the female terminal.

### Means to Solve the Problem

The present disclosure is directed to a connector with a wire including a core wire and an insulation coating covering an outer periphery of the core wire, a terminal to be connected to the core wire, a connector housing including a terminal accommodating portion for accommodating the terminal inside, and a rear holder to be attached to a rear part of the connector housing, the rear holder including a wire insertion hole, the wire being inserted through the wire insertion hole, the terminal including an insertion tube portion, the core wire being inserted into the insertion tube portion from behind, and a contact portion disposed in a rear end part of the insertion tube portion and facing the wire insertion hole, the insulation coating of the wire including a sheath portion and a body portion separate from each other, and the sheath portion being disposed forward of the body portion and slidable with respect to the core wire.

### Effect of the Invention

According to the present disclosure, it is possible to provide a connector in which a core wire is easily inserted into the inside of a terminal.

### BRIEF DESCRIPTION OF THE DRAWINGS

FIG. 1 is a perspective view of a connector according to an embodiment.

FIG. 2 is an exploded perspective view of the connector.

FIG. 3 is a front view of the connector.

FIG. 4 is a section along A-A of FIG. 3.

FIG. 5 is a view showing a state where a wire is inserted in a wire insertion hole and a sheath portion is in contact with a rear end part of a terminal in a cross-section along A-A of FIG. 3.

FIG. 6 is a view showing a state where the wire is pushed further forward from the state of FIG. 5 and the sheath portion is slid with respect to a core wire in the cross-section along A-A of FIG. 3.

FIG. 7 is a view showing a state where the wire is pushed further forward from the state of FIG. 6 and the core wire is inside the terminal in the cross-section along A-A of FIG. 3.

FIG. 8 is a section showing a wire by a two-dot chain line in a cross-section along B-B of FIG. 5.

### DETAILED DESCRIPTION TO EXECUTE THE INVENTION

### DESCRIPTION OF EMBODIMENTS OF PRESENT DISCLOSURE

First, embodiments of the present disclosure are listed and described below.

(1) The connector of the present disclosure is provided with a wire including a core wire and an insulation coating covering an outer periphery of the core wire, a terminal to be connected to the core wire, a connector housing including a terminal accommodating portion for accommodating the terminal inside, and a rear holder to be attached to a rear part of the connector housing, the rear holder including a wire insertion hole, the wire being inserted through the wire insertion hole, the terminal including an insertion tube portion, the core wire being inserted into the insertion tube portion from behind, and a contact portion disposed in a rear end part of the insertion tube portion and facing the wire insertion hole, the insulation coating of the wire including a sheath portion and a body portion separate from each other, and the sheath portion being disposed forward of the body portion and slidable with respect to the core wire.

According to this configuration, the sheath portion comes into contact with the contact portion by inserting the wire into the wire insertion hole with a front end part of the core wire protected by the sheath portion. With the sheath portion held in contact with the contact portion, the core wire immediately behind the insertion tube portion is substantially in a center of the sheath portion and disposed near a center of the wire insertion hole. Therefore, the core wire is easily inserted into the insertion tube portion.

(2) Preferably, the insertion tube portion includes a first wall portion and a second wall portion facing the first wall portion, a clearance between the first and second wall portions is set to be smaller than an outer diameter of the wire, and both the first and second wall portions include the contact portion.

According to this configuration, since both the first and second wall portions include the contact portion, a state of the sheath portion in contact with the contact portion can be stabilized. In this way, the core wire is more easily inserted into the insertion tube portion.

(3) Preferably, the rear holder includes a guiding portion projecting more inwardly of the wire insertion hole from an inner wall of the wire insertion hole toward front.

According to this configuration, the sheath portion can be guided by being caused to slide in contact with the guiding portion. Thus, the core wire is even more easily inserted into the insertion tube portion.

(4) A connector manufacturing method of the present disclosure is a manufacturing method for a connector with a wire including a core wire and an insulation coating covering an outer periphery of the core wire, a terminal including an insertion tube portion, the core wire being inserted into the insertion tube portion from behind, a connector housing including a terminal accommodating portion, and a rear holder including a wire insertion hole, and includes accommodating the terminal inside the terminal accommodating portion, attaching the rear holder to a rear part of the connector housing with a rear end part of the insertion tube portion at least partially arranged to face the wire insertion hole, forming a sheath portion and a body portion disposed rearward of the sheath portion by cutting off a front end part of the insulation coating of the wire, protecting a front end part of the core wire by the sheath portion by sliding the sheath portion forward with respect to the core wire, inserting the wire having the front end part of the core wire protected by the sheath portion into the wire insertion hole of the rear holder and introducing the core wire into the insertion tube portion while bringing the sheath portion into contact with the rear end part of the insertion tube portion, and connecting the core wire and the terminal.

Since this connector manufacturing method includes forming the sheath portion in the insulation coating and protecting the front end part of the core wire by the sheath portion, the sheath portion comes into contact with the rear end part of the insertion tube portion if the wire is inserted into the wire insertion hole. With the sheath portion held in contact with the rear end part of the insertion tube portion, the core wire immediately behind the insertion tube portion is substantially in a center of the sheath portion and disposed near a center of the wire insertion hole. Therefore, the core wire is easily inserted into the insertion tube portion.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

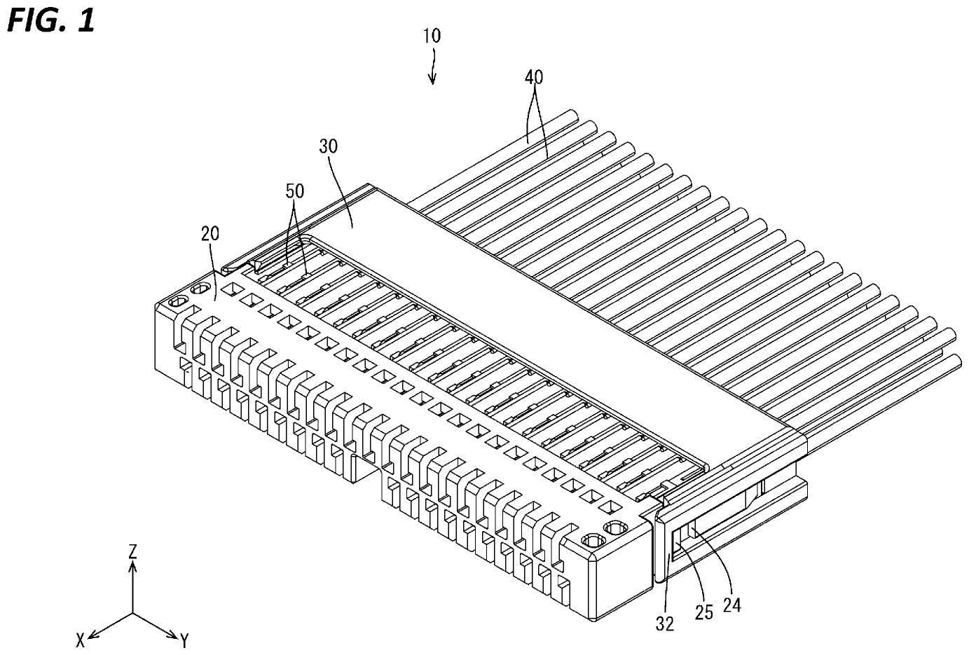

The embodiment of the present disclosure is described with reference to FIGS. 1 to 8. In the following description, a direction indicated by an arrow Z is referred to as an upward direction, a direction indicated by an arrow X is referred to as a forward direction and a direction indicated by an arrow Y is referred to as a leftward direction. Note that, for a plurality of identical members, only some members may be denoted by a reference sign and the other members may not be denoted by the reference sign.

### Connector

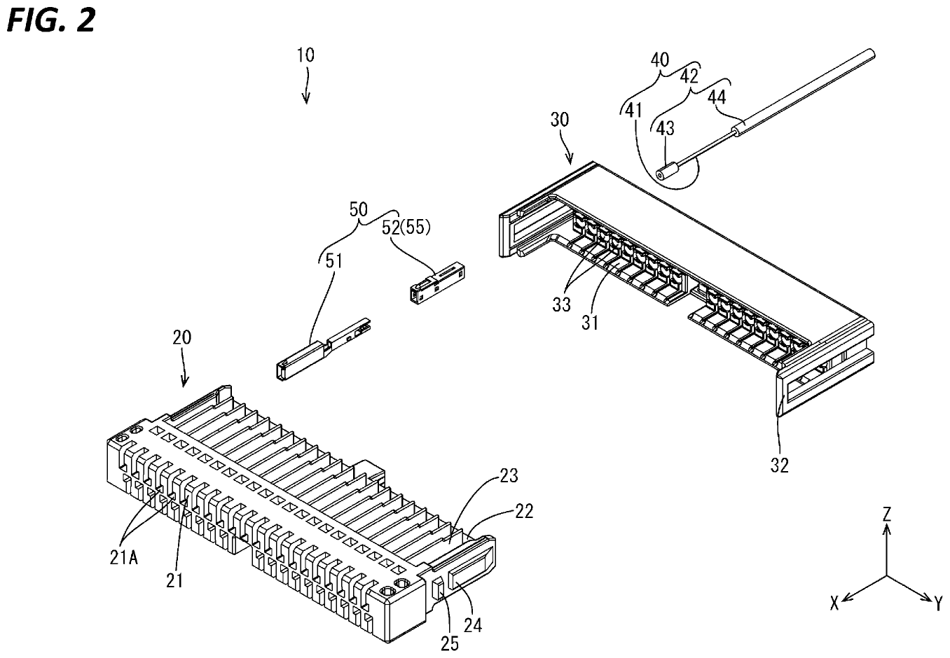

As shown in FIGS. 1 and 2, the connector 10 is provided with a connector housing 20, a rear holder 30, wires 40 and terminals 50.

### Wire

The wire 40 is provided with a core wire 41 and an insulation coating 42 made of insulating synthetic resin for surrounding the outer peripheral surface of the core wire 41. The insulation coating 42 is stripped in an end part of the wire 40 to expose the core wire 41. The core wire 41 is a so-called single-core wire composed of one metal wire. Note that the core wire 41 may be a stranded wire formed by twisting a plurality of thin metal wires. An arbitrary metal such as copper, copper alloy, aluminum or aluminum alloy can be appropriately selected as a metal constituting the core wire 41 if necessary. The core wire 41 of this embodiment is made of copper or copper alloy.

### Sheath Portion, Body Portion

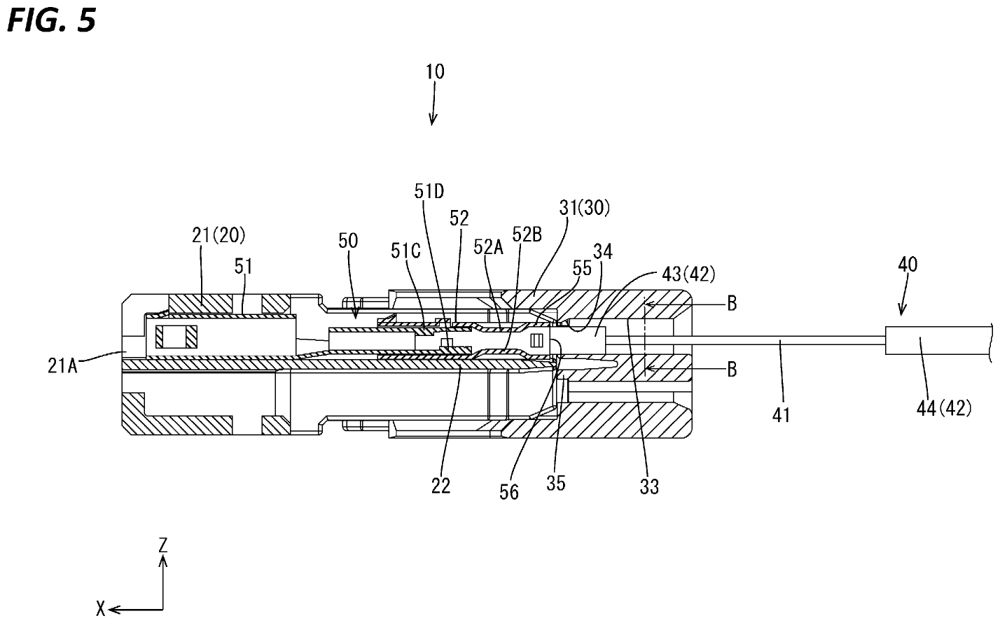

The insulation coating 42 is provided with a sheath portion 43 and a body portion 44 separate from the sheath portion 43 and disposed behind the sheath portion 43. The sheath portion 43 is slidable in an extension direction (front-rear direction) of the wire 40 with respect to the core wire 41. The sheath portion 43 is formed by being cut off from the body portion 44 by a wire stripper or the like. Although described later, the wire 40 is inserted through a wire insertion hole 33 of the rear holder 30 with a front end part of the core wire 41 protected by the sheath portion 43 (see FIGS. 2 and 5).

### Terminal

The terminal 50 is a female terminal and provided with a terminal body 51 made of metal and a slide portion 52 relatively slidable with respect to the terminal body 51. The terminal body 51 is formed into a predetermined shape by a known method such as press-working, cutting or casting. An arbitrary metal such as copper, copper alloy, aluminum, aluminum alloy or stainless steel can be appropriately selected as a metal constituting the terminal body 51 if necessary. The terminal body 51 of this embodiment is made of copper or copper alloy. A plating layer may be formed on the surface of the terminal body 51. An arbitrary metal such as tin, nickel or silver can be appropriately selected as a metal constituting the plating layer if necessary. Tin plating is applied to the terminal body 51 of this embodiment.

### Terminal Body

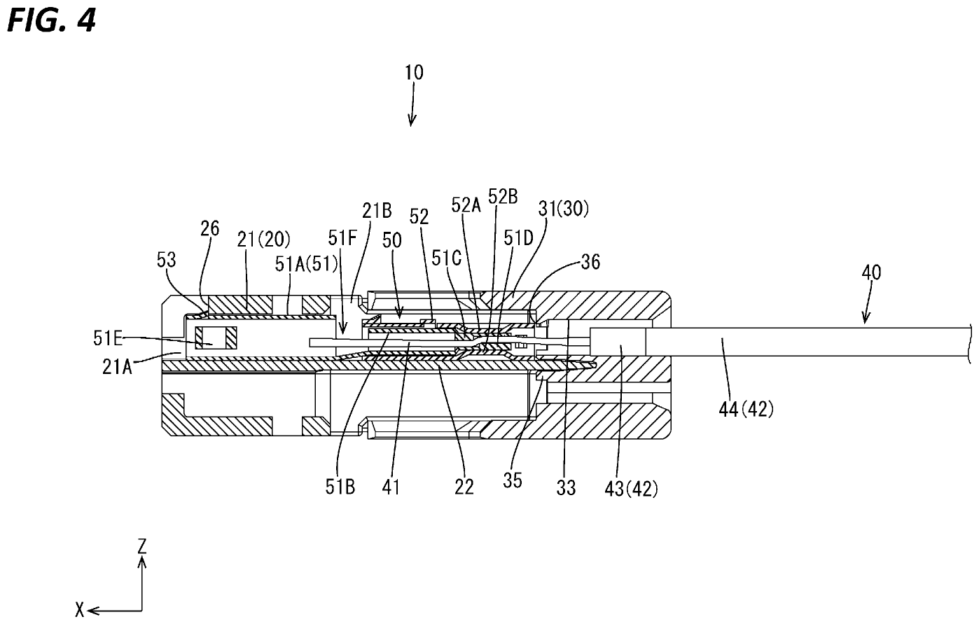

As shown in FIG. 4, the terminal body 51 includes a connecting tube portion 51A in the form of a rectangular tube, into which a mating male terminal (not shown) is inserted, a base portion 51B in the form of a rectangular tube disposed behind the connecting tube portion 51A and an upper connection piece 51C and a lower connection piece 51D extending rearward from the base portion 51B. The front end of the connecting tube portion 51A is open to enable the insertion of the mating male terminal.

A resiliently deformable resilient contact piece 51E is disposed on a side wall of the connecting tube portion 51A. The male terminal inserted into the connecting tube portion 51A contacts the resilient contact piece 51E. Further, a front end part of the upper wall of the connecting tube portion 51A is provided with a locking lance 53 made of metal and formed by cutting and raising a part of the connecting tube portion 51A.

The upper connection piece 51C is formed to be resiliently deformable in a vertical direction with a rear end part of the upper wall of the base portion 51B as a fulcrum. The lower connection piece 51D is formed to be resiliently deformable in the vertical direction with a rear end part of the lower wall of the base portion 51B as a fulcrum. The upper and lower connection pieces 51C, 51D are formed to have substantially the same length in a front-rear direction.

The terminal body 51 further includes a terminal window portion 51F open upward at a position behind the connecting tube portion 51A and in front of the base portion 51B. A front end part of the core wire 41 can be detected through the terminal window portion 51F with the core wire 41 disposed in a space between the upper and lower connection pieces 51C, 51D. Detectable means visually confirmable from outside by a worker, detectable from outside by a camera (not shown) or capable of electrically detecting the front end part of the core wire 41 by inserting a probe (not shown) from outside.

### Slide Portion

The slide portion 52 is in the form of a rectangular tube extending in the front-rear direction. The slide portion 52 is formed by a known method such as cutting, casting or press-working if necessary. An arbitrary metal such as copper, copper alloy, aluminum, aluminum alloy or stainless steel can be appropriately selected as a metal constituting the slide portion 52 if necessary. The slide portion 52 of this embodiment is made of copper or copper alloy. A plating layer may be formed on the surface of the slide portion 52. An arbitrary metal such as tin, nickel or silver can be appropriately selected as a metal constituting the plating layer if necessary. Tin plating is applied to the slide portion 52 of this embodiment.

A cross-sectional shape of the slide portion 52 is the same as or somewhat larger than that of a region of the terminal body 51 where the upper and lower connection pieces 51C, 52D are provided. In this way, the slide portion 52 is externally fittable to the region of the terminal body 51 where the upper and lower connection pieces 51C, 52D are provided.

An upper contact portion 52A projecting downward is provided on the lower surface of the upper wall of the slide portion 52. A lower contact portion 52B projecting upward is provided on the upper surface of the lower wall of the slide portion 52.

The slide portion 52 is slidable between a temporary locking position (position of the slide portion 52 in FIGS. 5 to 7) and a complete locking position (position of the slide portion 52 in FIG. 4) set to be forward of the temporary locking position in a state externally fit to the region of the terminal body 51 where the upper and lower connection pieces 51C, 51D are provided. With the slide portion 52 held at the complete locking position with respect to the terminal body 51, the upper contact portion 52A is in contact with the upper surface of the upper connection piece 51C from above and the lower contact portion 52B is in contact with the lower surface of the lower connection piece 51D from below.

With the slide portion 52 held at the complete locking position with respect to the terminal body 51, the upper contact portion 52A presses the upper connection piece 51C from above, whereby the upper connection piece 51C is resiliently deformed downward. Further, the lower contact portion 52B presses the lower connection piece 51D from below, whereby the lower connection piece 51D is resiliently deformed upward. In this way, the core wire 41 is sandwiched in the vertical direction by the resiliently deformed upper and lower connection pieces 51C, 51D in a state where the core wire 41 is disposed to extend in the front-rear direction in the space between the upper and lower connection pieces 51C, 51D and the slide portion 52 is held at the complete locking position with respect to the terminal body 51. That is, the upper connection piece 51C contacts the core wire 41 from above by being pressed downward by the upper contact portion 52A, and the lower connection piece 51D contacts the core wire 41 from below by being pressed upward by the lower contact portion 52B.

A front part of the upper connection piece 51C projects downward, a rear part of the lower connection piece 51D projects upward, and these projecting parts are shifted in the front-rear direction. Thus, the core wire 41 is held in a state bent in the vertical direction. In this way, the core wire 41 is electrically connected to the terminal 50 and firmly held not to come out against the rearward pulling of the wire 40.

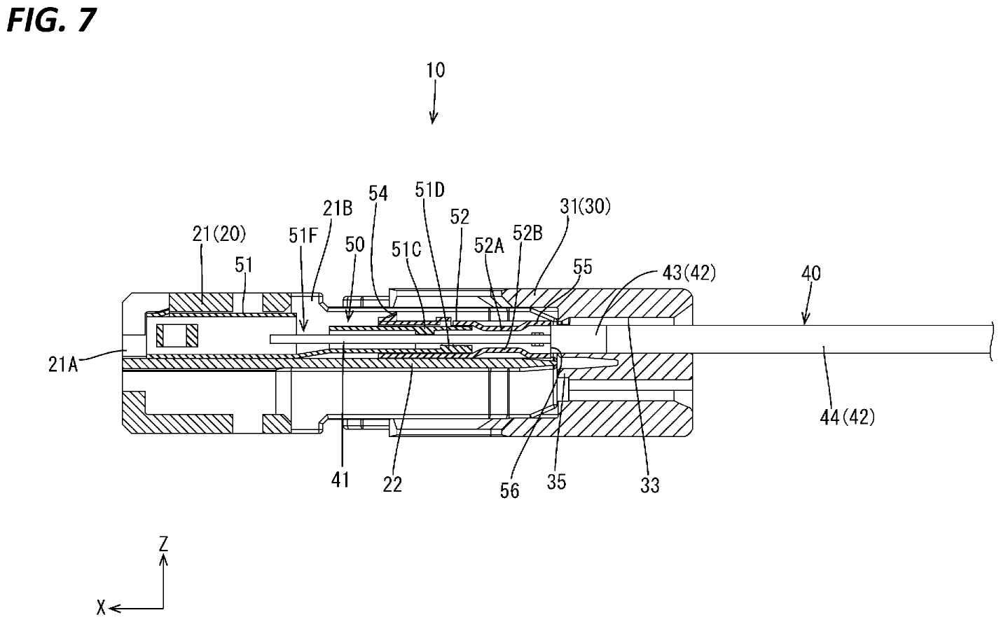

As shown in FIG. 7, the front end part of the slide portion 52 is provided with a jig contact portion 54 projecting upward from the upper wall. An unillustrated jig comes into contact with the jig contact portion 54 from behind and the slide portion 52 is pushed forward by the jig, whereby the slide portion 52 is movable forward.

### Insertion Tube Portion, First Wall Portion, Second Wall Portion

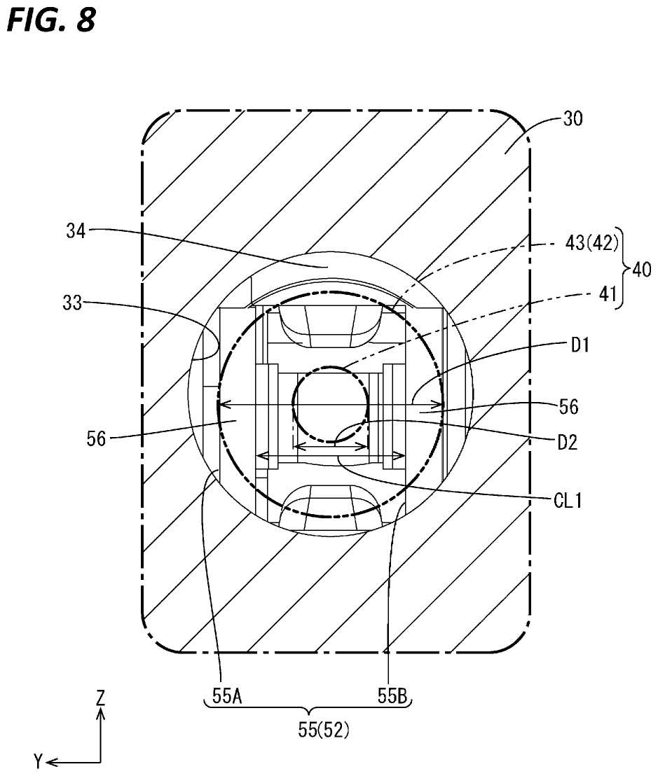

As shown in FIGS. 5 to 7, the slide portion 52 serves as an insertion tube portion 55, into which the core wire 41 is inserted. As shown in FIG. 8, the left wall of the insertion tube portion 55 serves as a first wall portion 55A. The right wall of the insertion tube portion 55 serves as a second wall portion 55B. The first and second wall portions 55A, 55B are facing each other in a direction (lateral direction) orthogonal to the extension direction (front-rear direction) of the wire 40. The upper end edges of the first and second wall portions 55A, 55B are connected by an upper wall. The lower end edges of the first and second wall portions 55A, 55B are connected by a lower wall. A clearance CL1 in the lateral direction between the first and second wall portions 55A, 55B is set to be smaller than an outer diameter D1 of the wire 40 (insulation coating 42) and larger than a diameter D2 of the core wire 41.

### Contact Portions

At least parts of a rear end part of the insertion tube portion 55 serve as contact portions 56 disposed to face the wire insertion hole 33 of the rear holder 30. That is, the rear end part of the insertion tube portion 55 is at least partially disposed inside the wire insertion hole 33 when viewed from behind. In this embodiment, both the first and second wall portions 55A, 55B include the contact portion 56. Although described later, the contact portions 56 can come into contact with the sheath portion 43 disposed in a tip part of the wire 40 when the wire 40 is inserted into the wire insertion hole 33 (see FIGS. 5 to 7).

### Connector Housing

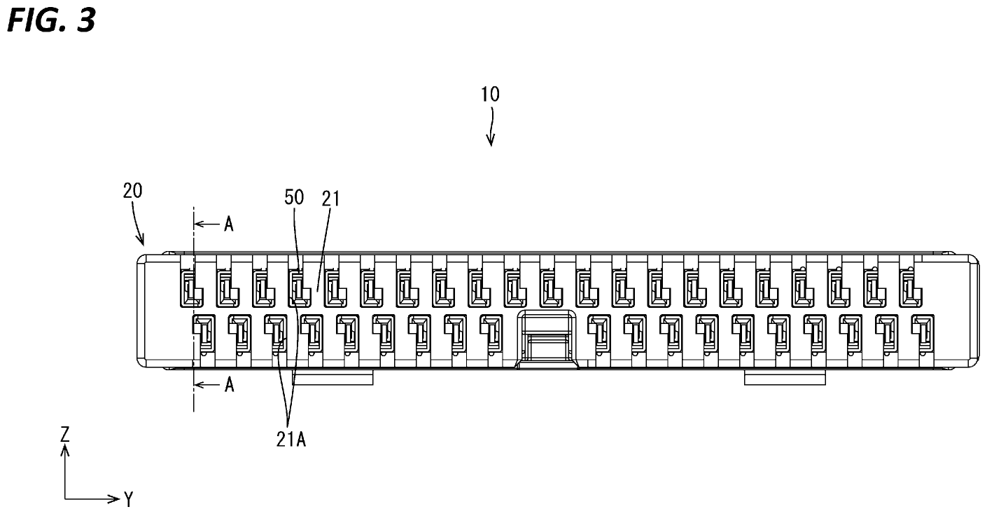

As shown in FIGS. 2 and 3, the connector housing 20 is made of insulating synthetic resin and includes a terminal accommodating portion 21 for accommodating the plurality of terminals 50. The connector housing 20 has a substantially rectangular parallelepiped shape flat in the vertical direction and extending in the lateral direction. The terminal accommodating portion 21 includes a plurality of cavities 21A penetrating therethrough in the front-rear direction. The plurality of cavities 21 are arranged in parallel at intervals in the lateral direction in two upper and lower stages. The cavities 21A formed in the upper stage and the cavities 21 formed in the lower stage are disposed at positions shifted in the lateral direction when viewed from above. Note that the number of the cavities 21A is arbitrary and the number of the stages in the vertical direction is also arbitrary.

The unillustrated male terminal is insertable into the cavity 21A from front. As shown in FIG. 4, the terminal 50 is inserted into the cavity 21A from behind and can be accommodated inside the terminal accommodating portion 21.

With the terminal 50 accommodated in the cavity 21A, a connector window portion 21B is formed at a position corresponding to the terminal window portion 51F of the terminal 50 in the terminal accommodating portion 21. By this connector window portion 21B, the terminal window portion 51F communicates with outside. The terminal window portion 51F of the terminal 50 is detectable through the connector window portion 21B. In this way, the front end part of the core wire 41 is detectable from outside through the connector window portion 21B and the terminal window portion 51F.

As shown in FIG. 2, the connector housing 20 includes a separation wall 22 partitioning between the cavities 21A in the upper stage and the cavities 21A in the lower stage. The separation wall 22 extends rearward from rear end parts of the cavities 21A. Partition walls 23 extending in the front-rear direction and projecting upward or downward are respectively provided on the upper and lower surfaces of the separation wall 22. The terminals 50 accommodated in the respective cavities 21A are electrically insulated from the terminals 50 adjacent in the lateral direction by these partition walls 23.

Temporary lock portions 24 projecting outward are provided at positions near rear end parts of both left and right side walls of the connector housing 20, and complete locking portions 25 are provided at positions forward of these temporary locking portions 24.

As shown in FIG. 4, a lance hole 26 open upward is provided on a front end side of the cavity 21A in the upper stage, and a lance hole 26 open downward is provided on a front end side of the cavity 21A in the lower stage. The locking lance 53 of the terminal 50 is locked to an inner wall constituting the lance hole 26, whereby the terminal 50 is held in a state accommodated in the cavity 21A.

### Rear Holder

The rear holder 30 is made of insulating synthetic resin. The rear holder 30 includes a box-shaped receptacle 31 open forward. The receptacle 31 is fit to a rear half of the connector housing 20 from outside. As shown in FIG. 2, lock receiving portions 32 are provided at positions near front end parts of both left and right side walls of the rear holder 30. The lock receiving portion 32 is substantially gate-shaped.

By locking the temporary lock portions 24 of the connector housing 20 and the lock receiving portions 32 of the rear holder 30, the rear holder 30 is held at a temporary locking position with respect to the connector housing 20. Further, by locking the complete lock portions 25 of the connector housing 20 and the lock receiving portions 32 of the rear holder 30, the rear holder 30 is held at a complete locking position with respect to the connector housing 20 (see FIG. 1).

As shown in FIG. 2, the rear holder 30 includes a plurality of wire insertion holes 33, through which the wires 40 are inserted. The plurality of wire insertion holes 33 are arranged in parallel in the lateral direction and provided in two upper and lower stages. The respective wire insertion holes 33 are provided at positions corresponding to the respective cavities 21A of the connector housing 20. An inner diameter of the wire insertion hole 33 is set to be equal to or somewhat larger than the outer diameter D1 of the insulation coating 42 of the wire 40. In this embodiment, as shown in FIG. 8, the inner diameter of the wire insertion hole 33 is larger than the outer diameter D1 of the insulation coating 42 of the wire 40. Even if the sheath portion 43 is shifted from a center position of the wire insertion hole 33 and the sheath portion 43 slides in contact with the inner wall of the wire insertion hole 33, the core wire 41 is disposed inside the insertion tube portion 55 when viewed from behind.

### Guiding Portion

As shown in FIG. 5, the rear holder 30 includes a guiding portion 34 on the inner wall of the wire insertion hole 33. The guiding portion 34 is disposed on the front end of the wire insertion hole 33. The guiding portion 34 is formed into a curved surface located more inwardly of the wire insertion hole 33 toward the front. The sheath portion 43 slides in contact with the guiding portion 34, thereby being guided into the wire insertion hole 33. In this embodiment, the guiding portion 34 is provided on the inner wall on an upper side of the wire insertion hole 33 in the wire insertion hole 33 in the upper stage, and located lower toward the front. Although not shown, the guiding portion 34 is provided on the inner wall on a lower side of the wire insertion hole 33 in the wire insertion hole 33 in the lower stage, and located higher toward the front.

In this embodiment, in the terminal 50 accommodated in the terminal accommodating portion 21 in the upper stage, a center position in the vertical direction of the insertion tube portion 55 is shifted downward with respect to a center position in the vertical direction of the wire insertion hole 33 in the upper stage as shown in FIGS. 5 and 8. However, since the rear holder 30 of this embodiment is provided with the guiding portion 34 projecting downward from the inner wall of the wire insertion hole 33 on the front end of the wire insertion hole 33 in the upper stage, the sheath portion 43 can be guided to a position below the center position in the vertical direction of the wire insertion hole 33 by the guiding portion 34. In this way, the core wire 41 disposed substantially in a center of the sheath portion 43 approaches the center position of the insertion tube portion 55, wherefore the insertion of the core wire 41 into the insertion tube portion 55 is facilitated.

Although not shown, the guiding portion 34 projects upward in the wire insertion hole 33 in the lower stage and guides the sheath portion 43 upward. Since the insertion tube portion 55 of the terminal 50 disposed in the terminal accommodating portion 21 in the lower stage is shifted upward with respect to the wire insertion hole 33, the insertion of the core wire 41 into the insertion tube portion 55 is facilitated by the guiding portion 34.

As shown in FIG. 5, a separation wall receiving portion 35 is provided near a vertical center in the back wall of the receptacle 31. This separation wall receiving portion 35 is open forward and a vertical dimension of an opening is set to be equal to or somewhat larger than a vertical thickness of the separation wall 22 of the connector housing 20.

With the rear holder 30 held at the temporary locking position with respect to the connector housing 20, the separation wall receiving portion 35 is located behind the rear end edge of the separation wall 22 of the connector housing 20. As shown in FIG. 4, with the rear holder 30 held at the complete locking position with respect to the connector housing 20, the separation wall 22 of the connector housing 20 is fit in the opening of the separation wall receiving portion 35 of the rear holder 30. In this way, a position shift of the rear holder 30 in the vertical direction with respect to the connector housing 20 is suppressed.

A step 36 is formed at the front end position of the wire insertion hole 33 on the inner wall of the receptacle 31. This step 36 comes into contact with a rear end part of the slide portion 52 from behind when the rear holder 30 is moved from the temporary locking position to the complete locking position with respect to the connector housing 20. In this way, the terminal 50 is held in a state accommodated in the cavity 21A of the connector housing 20 and prevented from coming out rearward.

### Connector Manufacturing Method

Next, an example of a manufacturing method of the connector 10 of this embodiment is described. The manufacturing method of the connector 10 is not limited to the one described below.

The terminal body 51 and the slide portion 52 are formed by a known method. The slide portion 52 is assembled with the terminal body 51 from behind, and held at the temporary locking position. In this way, the terminal 50 is obtained.

By injection-molding the synthetic resin, the connector housing 20 and the rear holder 30 are formed. The terminals 50 are inserted into the cavities 21A of the connector housing 20 from behind.

The rear holder 30 is assembled with the rear end part of the connector housing 20 from behind. Then, front end parts of the lock receiving portions 32 of the rear holder 30 come into contact with the temporary lock portions 24 of the connector housing 20 from behind and the lock receiving portions 32 are expanded and deformed. If the rear holder 30 is pushed further forward, the lock receiving portions 32 are restored and the lock receiving portions 32 of the rear holder 30 are resiliently locked to the temporary lock portions 24 of the connector housing 20. In this way, the rear holder 30 is held at the temporary locking position with respect to the connector housing 20.

By stripping the insulation coating 42 in the end part of the wire 40, the core wire 41 is exposed over a predetermined length. The front end part of the insulation coating 42 of the wire 40 is cut off by a wire stripper or the like to form the sheath portion 43 and the body portion 44. By sliding the sheath portion 43 forward with respect to the core wire 41, the front end part of the core wire 41 is protected by the sheath portion 43 (see FIG. 2).

Subsequently, the wire 40 having the front end part of the core wire 41 protected by the sheath portion 43 is inserted into the wire insertion hole 33 of the rear holder 30 (see FIG. 5). In this embodiment, by properly setting the inner diameter of the wire insertion hole 33, the core wire 41 disposed substantially in the center of the sheath portion 43 is disposed inside the insertion tube portion 55 when the sheath portion 43 disposed in the wire insertion hole 33 is viewed from behind (see FIG. 8). Further, the sheath portion 43 slides in contact with the guiding portion 34, thereby being guided in a projecting direction (downward in FIGS. 5 and 8) of the guiding portion 34 near the front end of the wire insertion hole 33. Since the insertion tube portion 55 is shifted in the projecting direction of the guiding portion 34 with respect to the wire insertion hole 33, the center positions in the vertical direction of the sheath portion 43 and the insertion tube portion 55 are more easily aligned by the guiding portion 34.

If the wire 40 is pushed further forward, the front end of the sheath portion 43 comes into contact with the contact portions 56 of the insertion tube portion 55. In this embodiment, since the contact portions 56 are provided on the first and second wall portions 55A, 55B as shown in FIG. 8, the posture of the front end of the sheath portion 43 is easily stabilized by contact with the contact portions 56. For example, the sheath portion 43 can be suppressed from being inclined from the state extending in the front-rear direction.

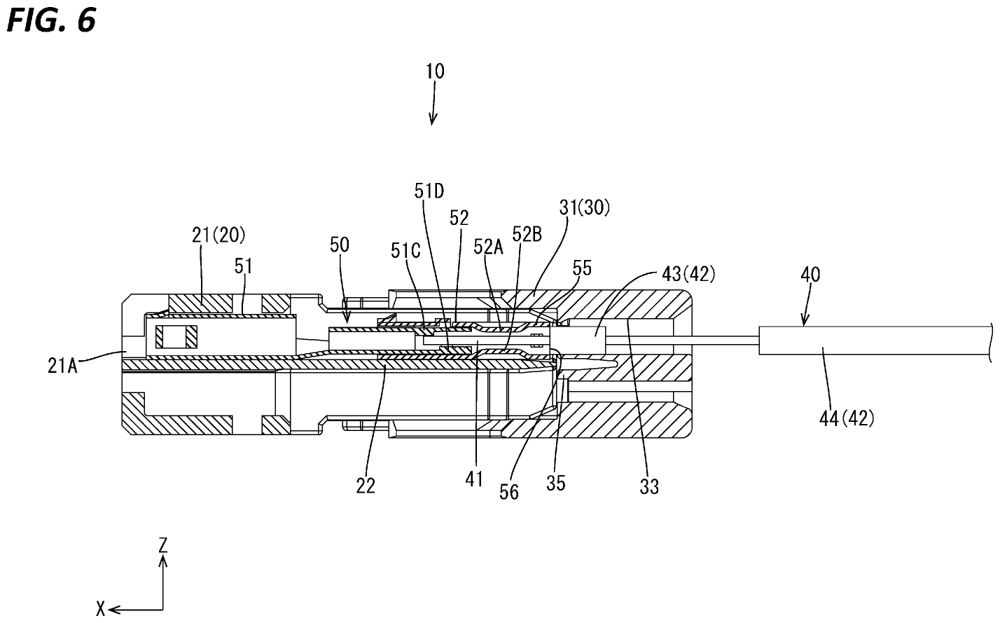

If the wire 40 is pushed further forward, the core wire 41 slides with respect to the sheath portion 43 and is fed into the insertion tube portion 55 (slide portion 52) with the sheath portion 43 kept in contact with the contact portions 56 as shown in FIG. 6. As described above, the core wire 41 disposed substantially in the center of the sheath portion 43 is disposed inside the insertion tube portion 55 when viewed from behind (see FIG. 8). Thus, with the sheath portion 43 held in contact with the contact portions 56, the front end part of the core wire 41 is disposed to face the inside of the insertion tube portion 55 at a position immediately behind the insertion tube portion 55. Therefore, the core wire 41 is more easily inserted into the insertion tube portion 55 as compared to the case where the sheath portion 43 is not provided.

If the wire 40 is pushed further forward, the front end part of the core wire 41 is inserted into the terminal body 51 and reaches the space between the upper and lower connection pieces 51C, 51D as shown in FIG. 7.

By seeing the front end part of the core wire 41 or detecting this front end part by a probe or the like in the terminal window portion 51F visually confirmable through the connector window portion 21B, it can be confirmed that the core wire 41 has reached a predetermined position.

Subsequently, if the jig (not shown) is pushed into contact with the jig contact portion 54 from behind and the slide portion 52 is slid forward, the slide portion 52 is held at the complete locking position with respect to the terminal body 51. With the slide portion 52 held at the complete locking position with respect to the terminal body 51, the upper contact portion 52A of the slide portion 52 contacts the upper connection piece 51C of the terminal body 51 from above to press the upper connection piece 51C downward as shown in FIG. 4. Further, the lower contact portion 52B of the slide portion 52 contacts the lower connection piece 51D of the terminal body 51 from below to press the lower connection piece 51D upward. In this way, the core wire 41 is sandwiched from upper and lower sides by the upper and lower connection pieces 51C, 51D and the terminal 50 and the wire 40 are electrically connected.

Subsequently, the rear holder 30 is pushed further forward with respect to the connector housing 20. Then, the front end parts of the lock receiving portions 32 of the rear holder 30 ride on the complete lock portions 25 and are expanded and deformed. If the rear holder 30 is pushed further forward, the lock receiving portions 32 are restored and the lock receiving portions 32 of the rear holder 30 are resiliently locked to the complete lock portions 25 of the connector housing 20. In this way, the rear holder 30 is held at the complete locking position with respect to the connector housing 20 (see FIG. 1). In this state, the receptacle 31 of the rear holder 30 is externally fit to the rear part of the connector housing 20 and the connector housing 20 and the rear holder 30 are integrally configured. In the above way, the manufacturing of the connector 10 is completed.

### Functions and Effects of Embodiment

According to the embodiment, the following functions and effects are achieved.

The connector 10 according to the embodiment is provided with the wires 40 each including the core wire 41 and the insulation coating 42 covering the outer periphery of the core wire 41, the terminals 50 to be connected to the core wires 41, the connector housing 20 including the terminal accommodating portion 21 for accommodating the terminals 50 inside, and the rear holder 30 to be attached to the rear part of the connector housing 20. The rear holder 30 includes the wire insertion holes 33, through which the wires 40 are inserted. The terminal 50 includes the insertion tube portion 55, into which the core wire 41 is inserted from behind, and the contact portions 56 disposed in the rear end part of the insertion tube portion 55 and facing the wire insertion hole 33. The insulation coating 42 of the wire 40 includes the sheath portion 43 and the body portion 44 separate from each other. The sheath portion 43 is disposed forward of the body portion 44 and slidable with respect to the core wire 41.

According to this configuration, by inserting the wire 40 into the wire insertion hole 33 with the front end part of the core wire 41 protected by the sheath portion 43, the sheath portion 43 comes into contact with the contact portions 56. With the sheath portion 43 held in contact with the contact portions 56, the core wire 41 immediately behind the insertion tube portion 55 is substantially in the center of the sheath portion 43 and disposed near the center of the wire insertion hole 33. Therefore, the core wire 41 is easily inserted into the insertion tube portion 55.

In the embodiment, the insertion tube portion 55 includes the first wall portion 55A and the second wall portion 55B facing the first wall portion 55A, the clearance CL1 between the first and second wall portions 55A, 55B is set to be smaller than the outer diameter D1 of the wire 40, and both the first and second wall portions 55A, 55B include the contact portion 56.

According to this configuration, since both the first and second wall portions 55A, 55B include the contact portion 56, the state of the sheath portion 43 in contact with the contact portions 56 can be easily stabilized. In this way, the core wire 41 is more easily inserted into the insertion tube portion 55.

In the embodiment, the rear holder 30 includes the guiding portion 34 projecting more inwardly of the wire insertion hole 33 from the inner wall of the wire insertion hole 33 toward the front.

According to this configuration, the sheath portion 43 can be guided by being caused to slide in contact with the guiding portion 34. Thus, the core wire 41 is even more easily inserted into the insertion tube portion 55.

In the embodiment, the manufacturing method of the connector 10 of the present disclosure is a manufacturing method for the connector 10 provided with the wires 40 each including the core wire 41 and the insulation coating 42 covering the outer periphery of the core wire 41, the terminals 50 provided with the insertion tube portions 55, into which the core wires 41 are inserted from behind, the connector housing 20 including the terminal accommodating portion 21, and the rear holder 30 including the wire insertion holes 33, and includes accommodating the terminals 50 inside the terminal accommodating portion 21, attaching the rear holder 30 to the rear part of the connector housing 20 with the rear end parts of the insertion tube portions 55 at least partially arranged to face the wire insertion holes 33, cutting off the front end part of the insulation coating 42 of the wire 40 to form the sheath portion 43 and the body portion 44 disposed behind the sheath portion 43, protecting the front end part of the core wire 41 by the sheath portion 43 by sliding the sheath portion 43 forward with respect to the core wire 41, inserting the wire 40 having the front end part of the core wire 41 protected by the sheath portion 43 into the wire insertion hole 33 of the rear holder 30 and introducing the core wire 41 into the insertion tube portion 55 while the sheath portion 43 is brought into contact with the rear end part of the insertion tube portion 55, and connecting the core wire 41 and the terminal 50.

Since such a manufacturing method of the connector 10 includes forming the sheath portion 43 in the insulation coating 42 and protecting the front end part of the core wire 41 by the sheath portion 43, the sheath portion 43 comes into contact with the rear end part of the insertion tube portion 55 if the wire 40 is inserted into the wire insertion hole 33. With the sheath portion 43 held in contact with the rear end part of the insertion tube portion 55, the core wire 41 immediately behind the insertion tube portion 55 is located substantially in the center of the sheath portion 43 and disposed near the center of the wire insertion hole 33. Therefore, the core wire 41 is easily inserted into the insertion tube portion 55.

### Other Embodiments

(1) Although both the first and second wall portions 55A, 55B of the insertion tube portion 55 include the contact portion 56 in the above embodiment, there is no limitation to this and at least a part of a rear end part of an insertion tube portion may include a contact portion.
(2) Although the rear holder 30 is provided with the guiding portions 34 in the above embodiment, there is no limitation to this and the guiding portions may be omitted.

### LIST OF REFERENCE NUMERALS

10: connector
20 connector housing
21: terminal accommodating portion
21A: cavity
21B: connector window portion
22 separation wall
23: partition wall
24: temporary lock portion
25 complete lock portion
26: lance hole
30: rear holder
31: receptacle
32: lock receiving portion
33: wire insertion hole
34: guiding portion
35: separation wall receiving portion
36: step
40: wire
41: core wire
42: insulation coating
43: sheath portion
44: body portion
50: terminal
51: terminal body
51A: connecting tube portion
51B: base portion
51C: upper connection piece
51D: lower connection piece
51E: resilient contact piece
51F: terminal window portion
52: slide portion
52A: upper contact portion
52B: lower contact portion
53: locking lance
54: jig contact portion
55: insertion tube portion
55A: first wall portion
55B: second wall portion
56: contact portion
CL1: clearance between first and second wall portions
D1: outer diameter of wire
D2: diameter of core wire

1. A connector, comprising:
a wire including a core wire and an insulation coating covering an outer periphery of the core wire;
a terminal to be connected to the core wire;
a connector housing including a terminal accommodating portion for accommodating the terminal inside; and
a rear holder to be attached to a rear part of the connector housing,
the rear holder including a wire insertion hole, the wire being inserted through the wire insertion hole,
the terminal including an insertion tube portion, the core wire being inserted into the insertion tube portion from behind, and a contact portion disposed in a rear end part of the insertion tube portion and facing the wire insertion hole,
the insulation coating of the wire including a sheath portion and a body portion separate from each other, and
the sheath portion being disposed forward of the body portion and slidable with respect to the core wire.

2. The connector of claim 1, wherein:
the insertion tube portion includes a first wall portion and a second wall portion facing the first wall portion,
a clearance between the first and second wall portions is set to be smaller than an outer diameter of the wire, and
both the first and second wall portions include the contact portion.

3. The connector of claim 1, wherein the rear holder includes a guiding portion projecting more inwardly of the wire insertion hole from an inner wall of the wire insertion hole toward front.

4. A connector manufacturing method for a connector with a wire including a core wire and an insulation coating covering an outer periphery of the core wire, a terminal including an insertion tube portion, the core wire being inserted into the insertion tube portion from behind, a connector housing including a terminal accommodating portion, and a rear holder including a wire insertion hole, comprising:
accommodating the terminal inside the terminal accommodating portion;
attaching the rear holder to a rear part of the connector housing with a rear end part of the insertion tube portion at least partially arranged to face the wire insertion hole;
forming a sheath portion and a body portion disposed rearward of the sheath portion by cutting off a front end part of the insulation coating of the wire;
protecting a front end part of the core wire by the sheath portion by sliding the sheath portion forward with respect to the core wire;
inserting the wire having the front end part of the core wire protected by the sheath portion into the wire insertion hole of the rear holder and introducing the core wire into the insertion tube portion while bringing the sheath portion into contact with the rear end part of the insertion tube portion; and
connecting the core wire and the terminal.
